(19) United States
(12) Patent Application Publication
(10) Pub. No.: US 2024/0209244 A1
(43) Pub. Date: Jun. 27, 2024

(54) EPOXY RESIN CURABLE COMPOSITION AND ADHESIVE CONTAINING THE SAME

(71) Applicant: Toray Fine Chemicals Co., Ltd., Tokyo (JP)

(72) Inventors: Hiromitsu Abe, Ichihara-shi, Chiba (JP); Motoharu Seo, Ichihara-shi, Chiba (JP)

(73) Assignee: Toray Fine Chemicals Co., Ltd., Tokyo (JP)

(21) Appl. No.: 18/287,198

(22) PCT Filed: Apr. 22, 2022
(86) PCT No.: PCT/JP2022/018541

§ 371 Date: Oct. 17, 2023

(30) Foreign Application Priority Data
Apr. 28, 2021 (JP) 2021-076164

(51) Int. Cl. C09J 11/06; C08K 5/17; C08K 5/37; C09J 163/00

(52) U.S. Cl. CPC C09J 11/06; C08K 5/17; C08K 5/37; C09J 163/00

(57) ABSTRACT

An epoxy resin curable composition cures quickly, has high hardness after curing, and an excellent color tone. An epoxy resin curable composition contains an epoxy resin containing two or more epoxy groups in one molecule, a thiol compound containing two or more thiol groups in one molecule, an amine compound A containing a primary amino group and/or a secondary amino group, and an amine compound B containing a tertiary amino group, in which a molar ratio M₁₊₂/Me is 0.11 to 0.5 and a molar ratio M₃/Me is 0.005 to 0.1, in which Me is the number of moles of the epoxy groups contained in the epoxy resin curable composition, M₁₊₂ is the total number of moles of the primary amino group and the secondary amino group, and M₃ is the number of moles of the tertiary amino group.

### TECHNICAL FIELD

This disclosure relates to an epoxy resin curable composition that cures quickly, has high hardness after curing and strong adhesive strength, and provides a cured product having an excellent color tone.

### BACKGROUND

Epoxy resin have excellent adhesiveness, chemical resistance, and physical properties, and are widely used as an adhesive and the like. For applications requiring rapid curing and high adhesive strength, a method of adding a thiol compound as a curing agent and amines as a curing accelerator is known.

Many terminal thiol group-containing compounds having no polysulfide skeleton in the main chain have been reported as compounds capable of rapidly reacting a thiol group with an epoxy group (see, for example, JP 8-269203 A). Among them, as a curing agent for an epoxy resin having both economic efficiency and safety, a compound containing a polyether skeleton in the main chain and containing three or more thiol groups in one molecule is widely commercially available. Examples of the compound containing a polyether skeleton in the main chain and three or more thiol groups in one molecule include “Polythiol QE-340M” manufactured by Toray Fine Chemicals Co., Ltd., and “Capcure3-800” and “GPM-800” manufactured by Gabriel Performance Products, LLC.

Examples of an amine widely used as a curing accelerator for a thiol group and an epoxy group include tertiary amines such as 2,4,6-tris(dimethylaminomethyl)phenol (ANCAMINE K-54 manufactured by Evonik Industries AG), N,N-dimethylpropylamine, and bis(2-dimethylaminoethyl)ether.

However, a known epoxy resin curable composition turns yellow and is colored when cured, and thus has a problem in applications required to be close to colorless and to have an excellent color tone such as an adhesive for glass and an adhesive for a decorative item.

A known colorless epoxy resin curable composition cures slowly, is not suitable for applications requiring rapid curing, and does not necessarily have sufficient hardness and adhesive strength. As described above, it has been difficult for an epoxy resin curable composition containing an epoxy resin, a thiol compound, and an amine compound to have quick curing, hardness, adhesive strength, and a color tone.

It could therefore be helpful to provide an epoxy resin curable composition that cures quickly, has high hardness after curing, and has strong adhesive strength and an excellent color tone.

### SUMMARY

An epoxy resin curable composition contains an epoxy resin containing two or more epoxy groups in one molecule, a thiol compound containing two or more thiol groups in one molecule, an amine compound A containing a primary amino group and/or a secondary amino group, and an amine compound B containing a tertiary amino group, in which a molar ratio M₁₊₂/Me is 0.11 to 0.5 and a molar ratio M₃/Me is 0.005 to 0.1, in which Me is the number of moles of the epoxy groups contained in the epoxy resin curable composition, M₁₊₂ is the total number of moles of the primary amino group and the secondary amino group, and M₃ is the number of moles of the tertiary amino group.

Our epoxy resin curable composition cures quickly, has high hardness after curing, and has strong adhesive strength and an excellent color tone.

When the epoxy resin curable composition is used as an adhesive, the adhesive strength is strong to various adherends such as a metal and glass. The epoxy resin curable composition can be used as an adhesive, a sealing material, a potting material, a coating agent, a modifier for a resin or the like.

In particular, since the epoxy resin curable composition has an excellent color tone, it is advantageous for an adhesive for glass, an adhesive for a decorative item, an adhesive for a timepiece part, an adhesive for electrical and electronic applications, a potting material for electrical and electronic applications, and an adhesive for DIY.

### DETAILED DESCRIPTION

Our epoxy resin curable composition contains an epoxy resin containing two or more epoxy groups in one molecule, a thiol compound containing two or more thiol groups in one molecule, an amine compound A containing a primary amino group and/or a secondary amino group, and an amine compound B containing a tertiary amino group.

Examples of the epoxy resin containing two or more epoxy groups in one molecule include an epoxy resin obtained by adding epichlorohydrin to a polyhydric phenol such as bisphenol A, bisphenol F, resorcinol, hydroquinone, pyrocatechol, 4,4-dihydroxybiphenyl, or 1,5-hydroxynaphthalene, an epoxy resin obtained by adding epichlorohydrin to a polyhydric alcohol such as ethylene glycol, propylene glycol, or glycerin, an epoxy resin obtained by adding epichlorohydrin to an aromatic dicarboxylic acid such as oxybenzoic acid or phthalic acid, and a polysulfide polymer containing an epoxy group at a terminal (trade names: “FLEP-50” and “FLEP-60,” both manufactured by Toray Fine Chemicals Co., Ltd.). The epoxy resin containing two or more epoxy groups in one molecule is preferably a liquid at normal temperature from the viewpoint of workability and suppression of mixing failure. Examples of the epoxy resin containing two or more epoxy groups in one molecule include jER-828 (trade name, manufactured by Mitsubishi Chemical Group Corporation), DER-331 (trade name, manufactured by The Dow Chemical Company), jER-825 (trade name, manufactured by Mitsubishi Chemical Group Corporation), jER-827 (trade name, manufactured by Mitsubishi Chemical Group Corporation), jER-806 (trade name, manufactured by Mitsubishi Chemical Group Corporation), and jER-807 (trade name, manufactured by Mitsubishi Chemical Group Corporation).

An epoxy equivalent of the epoxy resin containing two or more epoxy groups in one molecule is preferably 50 to 1,000 g/eq. The epoxy equivalent of the epoxy resin containing two or more epoxy groups in one molecule is more preferably 100 to 300 g/eq.

Examples of the thiol compound containing two or more thiol groups in one molecule include ethylene glycol bis(3-mercaptopropionate), diethylene glycol bis(3-mercaptopropionate), tetraethylene glycol bis(3-mercaptopropionate), 1,2-propylene glycol bis(3-mercaptopropionate), diethylene glycol bis(3-mercaptobutyrate), 1,4-butanediol bis(3-mercaptopropionate), 1,4-butanediol bis(3-mercaptobutyrate), 1,8-octanediol bis(3-mercaptopropionate), 1,8-octanediol bis(3-mercaptobutyrate), hexanediol bisthioglycolate, trimethylolpropane tris(3-mercaptopropionate), trimethylolpropane tris(3-mercaptobutyrate), trimethylolpropane tris(3-mercaptoisobutyrate), trimethylolpropane tris(2-mercaptoisobutyrate), trimethylolpropane tristhioglycolate, tris-[(3-mercaptopropionyloxy)-ethyl]-isocyanurate, trimethylolethane tris(3-mercaptobutyrate), pentaerythritol tetrakis(3-mercaptopropionate), pentaerythritol tetrakis(3-mercaptobutyrate), pentaerythritol tetrakis(3-mercaptoisobutyrate), pentaerythritol tetrakis(2-mercaptoisobutyrate), dipentaerythritol hexakis(3-mercaptopropionate), dipentaerythritol hexakis(2-mercaptopropionate), dipentaerythritol hexakis(3-mercaptobutyrate), dipentaerythritol hexakis(3-mercaptoisobutyrate), dipentaerythritol hexakis(2-mercaptoisobutyrate), pentaerythritol tetrakisthioglycolate, dipentaerythritol hexakisthioglycolate, and a thiol compound containing a polyether moiety in the main chain.

The thiol compound preferably contains three or more thiol groups in one molecule. Examples of such a thiol compound include trimethylolpropane tris(3-mercaptopropionate), pentaerythritol tetrakis(3-mercaptopropionate), trimethylolethane tris(3-mercaptobutyrate), and pentaerythritol tetrakis(3-mercaptoacetate).

The thiol compound containing two or more thiol groups in one molecule preferably contains a polyether moiety in the main chain, and may contain a thiol group on a carbon adjacent to a carbon having a hydroxy group. Furthermore, the thiol compound preferably does not contain a carbonyl group. When the thiol compound does not contain a carbonyl group, hydrolysis of a cured product is suppressed and water resistance is improved, which is preferable.

A structure having a polyether moiety in the main chain is preferably represented by Formula (1), and a terminal thiol group is preferably represented by Formula (2):

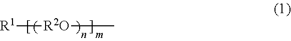

where R¹ is a residue obtained by removing m hydrogen atoms from a polyvalent amine or polyhydric alcohol having 10 or fewer carbon atoms, R² is an alkylene group having 2 to 4 carbon atoms, n is an integer of 1 to 200, and m is an integer of 2 to 8.

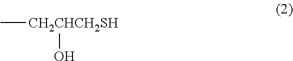

In Formula (1), R¹ is a residue obtained by removing m hydrogen atoms from a polyvalent amine or polyhydric alcohol having 10 or fewer carbon atoms. Examples of the polyvalent amine or polyhydric alcohol having 10 or fewer carbon atoms include glycerin, trimethylolpropane, trimethylolethane, hexanetriol, diglycerin, pentaerythritol, triethanolamine, ethylenediamine, and sucrose. These polyvalent amines and polyhydric alcohols may be used alone or in combination. Among the polyols described above, glycerin, trimethylolpropane, and trimethylolethane are particularly preferable.

In Formula (1), R² is an alkylene group having 2 to 4 carbon atoms. Examples of the alkylene group having 2 to 4 carbon atoms include ethylene, n-propylene, isopropylene, n-butylene, and isobutylene.

In Formula (1), n is an integer of 1 to 200 and preferably an integer of 1 to 100. In addition, m is an integer of 2 to 8 and preferably an integer of 2 to 5.

Examples of the thiol compound that has a structure represented by Formulas (1) and (2) include “Polythiol QE-340M” manufactured by Toray Fine Chemicals Co., Ltd., and “Capcure3-800” and “GPM-800” manufactured by Gabriel Performance Products, LLC. These thiol compounds preferably do not contain a carbonyl group.

The thiol compound containing two or more thiol groups in one molecule preferably contains at least one thiol group represented by Formula (2), and more preferably contains two or more thiol groups. In the thiol compound, all thiol groups may be contained as a structure represented by Formula (2).

In the thiol compound containing two or more thiol groups in one molecule, a content of the thiol groups is preferably 1 to 50 mass %, and the content of the thiol groups is more preferably 5 to 20 mass %.

The fact that the thiol compound does not contain a carbonyl group means that the thiol compound does not contain a carbonyl group, a carboxy group, a thiocarboxy group, an aldehyde group, an ester bond, a thioester bond, an amide bond and the like.

Blending amounts of the epoxy resin and the thiol compound described above can be determined so that a molar ratio Mt/Me of the number of moles Mt of the thiol groups derived from the thiol compound to the number of moles Me of the epoxy groups derived from the epoxy resin present in the epoxy resin curable composition is preferably 0.1 to 0.9, more preferably 0.2 to 0.8, still more preferably 0.2 to 0.7, and further still more preferably 0.32 to 0.64. When the molar ratio Mt/Me is set to 0.1 or more, curing is accelerated, which is preferable. In addition, when the molar ratio Mt/Me is set to 0.9 or less, a Shore D hardness of a cured product can be increased, which is preferable.

The blending amount of the thiol compound can be appropriately designed according to the physical properties of the epoxy resin curable composition, and preferably satisfies the relationship of the molar ratio Mt/Me. For example, it is preferable to blend 50 to 150 parts by mass of the thiol compound with respect to 100 parts by mass of an epoxy resin containing two or more epoxy groups in one molecule. When the amount of the thiol compound is 50 to 150 parts by mass with respect to 100 parts by mass of the epoxy resin, the epoxy resin curable composition cures quickly, has high hardness of a cured product, and has sufficient adhesive strength. The blending amount of the thiol compound with respect to 100 parts by mass of the epoxy resin is more preferably 60 to 120 parts by mass and more preferably 70 to 100 parts by mass.

The epoxy resin curable composition contains an amine compound A containing a primary amino group and/or a secondary amino group and an amine compound B containing a tertiary amino group. When the epoxy resin curable composition contains at least two types of amine compounds including the amine compound A and the amine compound B, the epoxy resin curable composition cures quickly, has high hardness after curing, and has high adhesive strength and an excellent color tone. The amine compound A may contain only a primary amino group derived from a primary amine, may contain only a secondary amino group derived from a secondary amine, or may contain a primary amino group derived from a primary amine and a secondary amino group derived from a secondary amine.

The amine compound A is preferably an aliphatic amine. Examples of the aliphatic amine include ethylenediamine, 1,2-diaminopropane, 1,3-diaminopropane, 1,5-diaminopentane, hexamethylenediamine, tetramethylenediamine, trimethylhexamethylenediamine, 2-methyl-1,5-diaminopentane, polyetherdiamine, diethylenetriamine, triethylenetetramine, tetraethylenepentamine, pentaethylenehexamine, dipropylenetriamine, bis(hexamethylene)triamine, N,N′-dimethylethylenediamine, and N,N-dimethyl-1,3-propanediamine. The amine compound A is preferably not an amine in which the amino group of the aliphatic amine is composed only of a secondary amino group. That is, the amine compound A may contain at least one primary amino group. In addition, it is preferable not to contain a tertiary amino group.

The amine compound A is more preferably an amine containing two or more primary amino groups and/or secondary amino groups in one molecule and containing no tertiary amino group. Examples of the amine compound A include ethylenediamine, 1,2-diaminopropane, 1,3-diaminopropane, 1,5-diaminopentane, hexamethylenediamine, tetramethylenediamine, trimethylhexamethylenediamine, 2-methyl-1,5-diaminopentane, polyetherdiamine, diethylenetriamine, triethylenetetramine, tetraethylenepentamine, pentaethylenehexamine, dipropylenetriamine, bis(hexamethylene)triamine, diethylenetriamine, triethylenetetramine, tetraethylenepentamine, pentaethylenehexamine, dipropylenetriamine, and bis(hexamethylene)triamine. Examples of the amine containing two or more amino groups in one molecule and containing no tertiary amino group in the molecule more preferably include ethylenediamine, diethylenetriamine, triethylenetetramine, 1,3-diaminopropane, and tetraethylenepentamine.

The amine compound A more preferably contains three or more primary amino groups and/or secondary amino groups in one molecule. The amine having three or more amino groups in one molecule is preferably diethylenetriamine, triethylenetetramine, tetraethylenepentamine, pentaethylenehexamine, dipropylenetriamine, or bis(hexamethylene)triamine, and more preferably triethylenetetramine.

The amine compound A is particularly preferably a modified product obtained by using an amine containing three or more primary amino groups and/or secondary amino groups in one molecule as a raw material. As the modified product obtained by using an amine containing three or more amino groups in one molecule as a raw material, a modified product of diethylenetriamine, a modified product of triethylenetetramine, a modified product of tetraethylenepentamine and the like are particularly preferable, and among them, a modified product obtained by reacting an amino group of triethylenetetramine with a mono- or polyepoxy compound is more preferable. Examples of the modified product obtained by using an amine containing three or more amino groups in one molecule as a raw material include “BB-AMINE 3138” manufactured by BB RESINS SRL.

The modified product obtained by using an amine containing three or more amino groups in one molecule as a raw material preferably has an amine value of 500 to 2,500 KOHmg/g, and more preferably has an amine value of 800 to 1,700 KOHmg/g.

The amine compound B is an amine containing a tertiary amino group derived from a tertiary amine. Examples of the amine compound B include trimethylamine, benzyldimethylamine, N,N,N′,N′-tetramethylethylenediamine, N,N,N′,N′-tetramethyl-1,3-diaminopropane, dimethylaniline, N,N-dimethyl-1,3-propanediamine, diazabicycloundecene, 2,4,6-tris(dimethylaminomethyl)phenol, ANCAMINE (registered trademark) K-54 (manufactured by Evonik Industries AG), and N,N′-bis(3-(dimethylamine)propyl urea. The amine compound B is preferably an amine containing two or more tertiary amino groups derived from a tertiary amine. More preferably, the amine compound B does not contain a primary amino group derived from a primary amine. Still more preferably, the amine compound B contains only a tertiary amino group derived from a tertiary amine, and does not contain a primary amino group derived from a primary amine and a secondary amino group derived from a secondary amine. By containing the amine compound B, the hardness of the cured product can be increased, and the adhesive strength can be increased.

The blending amount of the amine compound A can be determined so that a molar ratio M₁₊₂/Me of the total number of moles M₁₊₂ of the primary amino group and the secondary amino group to the number of moles Me of the epoxy groups derived from the epoxy resin in the epoxy resin curable composition is 0.11 to 0.5. The molar ratio M₁₊₂/Me is preferably 0.15 to 0.5, more preferably 0.2 to 0.5, and still more preferably 0.27 to 0.50. When the molar ratio M₁₊₂/Me is set to 0.11 or more, the color tone of the cured product is excellent, which is preferable. In addition, when the molar ratio M₁₊₂/Me is set to 0.5 or less, the Shore D hardness of the cured product can be increased, which is preferable.

The blending amount of the amine compound B can be determined so that a molar ratio M₃/Me of the number of moles M₃ of the tertiary amino group to the number of moles Me of the epoxy groups derived from the epoxy resin in the epoxy resin curable composition is 0.005 to 0.1. The molar ratio M₃/Me is preferably 0.01 to 0.095, more preferably 0.015 to 0.09, still more preferably 0.015 to 0.085, and further still more preferably 0.02 to 0.08. When the molar ratio M₃/Me is set to 0.005 or more, the Shore D hardness of the cured product is increased, which is preferable. In addition, when the molar ratio M₃/Me is set to 0.1 or less, the color tone of the cured product is excellent, which is preferable.

In the amine compound A and the amine compound B, a molar ratio M₃/M₁₊₂ of the number of moles M₃ of the tertiary amino group to the total number of moles M₁₊₂ of the primary amino group and the secondary amino group present in the epoxy resin curable composition is preferably 0.04 to 1.1. The molar ratio M₃/M₁₊₂ is more preferably 0.04 to 1.0, still more preferably 0.04 to 0.7, and further still more preferably 0.04 to 0.4. When the molar ratio M₃/M₁₊₂ is set to 0.04 or more, the Shore D hardness of the cured product is increased, which is preferable. In addition, when the molar ratio M₃/M₁₊₂ is set to 1.1 or less, the color tone of the cured product is excellent, which is preferable.

The blending amounts of the amine compound A and the amine compound B are appropriately designed according to the physical properties of the cured product, and are set to satisfy the relationships of the molar ratios M₁₊₂/Me and M₃/Me and to preferably satisfy the relationship of the molar ratio M₃/M₁₊₂. For example, it is preferable to blend 1 to 30 parts by mass of the amine compound A with respect to 100 parts by mass of an epoxy resin containing two or more epoxy groups in one molecule. When the amount of the amine compound A is 1 to 30 parts by mass with respect to 100 parts by mass of the epoxy resin, it is possible to obtain a cured product that cures quickly, has sufficient adhesive strength, and has excellent color toning property. The blending amount of the amine compound A with respect to 100 parts by mass of the epoxy resin is more preferably 2 to 30 parts by mass and more preferably 5 to 30 parts by mass.

For example, it is preferable to blend 0.5 to 10 parts by mass of the amine compound B with respect to 100 parts by mass of an epoxy resin containing two or more epoxy groups in one molecule. When the amount of the amine compound B is 0.5 to 10 parts by mass with respect to 100 parts by mass of the epoxy resin, a cured product having a high Shore D hardness and an excellent color tone can be obtained. The blending amount of the amine compound B with respect to 100 parts by mass of the epoxy resin is more preferably 1 to 9 parts by mass and more preferably 1 to 7 parts by mass.

Our epoxy resin curable composition cures at room temperature. The epoxy resin curable composition has an excellent color tone close to colorless and/or white after curing.

The excellent color tone means that a cured product having a thickness of 8 mm has a chromaticity a* of −10 to +10 and a chromaticity b* of −20 to +20 in an L*a*b* color system. When the chromaticity a* is out of the range of −10 to +10, the color tone becomes dark. A cured product having a thickness of 8 mm of the epoxy resin curable composition preferably has a chromaticity a* of −9 to +9 and a chromaticity b* of −17 to +19 in the L*a*b* color system. A cured product having a thickness of 8 mm of the epoxy resin curable composition after curing for 24 hours under conditions of 23° C. and 50% RH more preferably has a chromaticity a* of −8 to +8 and a chromaticity b* of −15 to +19 in the L*a*b* color system. The chromaticity a* of the cured product is more preferably −8 to +5 and still more preferably −7 to +1. The chromaticity b* of the cured product is more preferably −10 to +19, still more preferably −7 to +19, and particularly preferably −5 to +19.

In the color tone of the cured product having a thickness of 8 mm of the epoxy resin curable composition, a lightness L* is preferably 50 or more, more preferably 55 or more, and still more preferably 60 or more, in a color space of the L*a*b* color system.

The color space of the L*a*b* color system is one of color display methods established by the International Commission on Illumination (CIE) in 1976, and represented by the lightness (L* value), the degree of magenta and green (a* value), and the degree of yellow and blue (b* value) by physically measuring the stimulus amount of color light that causes color sensation. When the L* value is 0, black is represented, when the L* value is 100, white is represented, when the a* value is a negative value, a color close to green is represented, when the a* value is a positive value, a color close to red is represented, when the b* value is a negative value, a color close to blue is represented, and when the b* value is a positive value, a color close to yellow is represented.

The measurement method of the L*a*b* color space is obtained by performing measurement using a color difference meter (for example, trade name “CR-300” manufactured by Minolta Co., Ltd., color difference meter) which is a measurement apparatus specified in Japanese Industrial Standards JIS Z 8781-4:2013.

The epoxy resin curable composition preferably has a curing time of 1 to 20 minutes. As for the curing time of the epoxy resin curable composition, when 10 g of the epoxy resin curable composition is used and cured at 23° C. and 50% RH, the curing time is more preferably 1 to 15 minutes and still more preferably 1 to 10 minutes. When the curing time is 1 to 15 minutes, it is suitable and preferable for applications requiring rapid curing.

The measurement of the curing time was performed with reference to the method of determining a pot life of a multi-component adhesive described in JIS K 6870 (Method 1). The curing time was defined as a point at which a thiol compound and an amine compound were mixed at a predetermined ratio with 10 g of an epoxy resin under conditions of 23° C. and 50% RH, a toothpick was put in the epoxy resin curable composition, and the toothpick stopped moving.

When the epoxy resin curable composition is applied to a thickness of 6.0 mm or more and is cured at 23° C. and 50% RH, a Shore D hardness in accordance with JIS K7215 after 3 hours from the start of curing is preferably 75 or more, and the Shore D hardness in accordance with JIS K7215 after 24 hours from the start of curing is preferably 75 or more. When the Shore D hardness after 3 hours from the start of curing is 75 or more, a cured product having high adhesive strength is obtained, which is preferable. The Shore D hardness after 3 hours from the start of curing is more preferably 76 to 88 and still more preferably 77 to 85. In addition, when the Shore D hardness after 24 hours from the start of curing is 75 or more, a cured product having high adhesive strength is obtained, which is preferable. The Shore D hardness after 24 hours from the start of curing is more preferably 76 to 83 and still more preferably 78 to 84.

The epoxy resin curable composition may further contain a filler, a plasticizer, a flexibility imparting agent, a coupling agent, an antioxidant, a thixotropy imparting agent, a dispersant and the like as long as desired effects are not impaired.

Our epoxy resin curable composition adheres well to a metal, glass, stone, concrete and the like, and can be used as an adhesive having an excellent color tone. The adhesive containing the epoxy resin curable composition is preferable as, for example, an adhesive for an iron plate, an adhesive for glass, an adhesive for a decorative item, an adhesive for a timepiece part, and an adhesive for DIY, and is particularly preferable as an adhesive for glass, an adhesive for a decorative item, an adhesive for a timepiece part, and an adhesive for DIY.

### EXAMPLES

Examples and Comparative Examples are described below. In the following Examples, a general reagent purchased from a reagent manufacturer was used as a raw material unless otherwise specified. The following apparatus and method were used for the analysis.

### Curing Time

The curing time of the epoxy resin curable composition was defined as a curing time when a toothpick was put into the epoxy resin curable composition and the toothpick stopped moving with reference to the method of determining a pot life of a multi-component adhesive described in JIS K 6870 (Method 1). Specifically, under conditions of 23° ° C. and 50% RH, the epoxy resin curable composition obtained by mixing the raw materials according to each example was pierced with a toothpick, and the point at which the toothpick did not move was measured as the curing time. The curing time was measured from the start of mixing, and was determined in units of minutes by checking the state of the toothpick every 30 seconds. In Examples 1 to 7 and Comparative Examples 1 to 11, a thiol compound, an amine compound A, and an amine compound B were mixed at ratios shown in Tables 1 and 2 with 10 g of an epoxy resin.

### Hardness (Shore D Hardness)

The hardness of the epoxy resin curable composition was measured by the method specified in JIS K 7215. Specifically, the epoxy resin curable composition was poured into a plurality of containers having an inner diameter of 31 mm and a depth of 8 mm in a room at a temperature of 23° C. and a humidity of 50% RH, and after 3 hours and 24 hours from the start of mixing of the epoxy resin curable composition, samples for measurement having a diameter of 31×8 mm were obtained. The flat surface of the sample was measured using a type D durometer. The measurement was performed three times for each measurement sample, and an average value was taken as a hardness value.

### Lightness and Chromaticity

The lightness and chromaticity of the cured product of the epoxy resin were measured. Specifically, the epoxy resin curable composition according to each example was placed in a container having an inner diameter of 31 mm and a depth of 8 mm and curing was performed under conditions of 23° C. and 50% RH using a color difference meter (“CR-300” manufactured by Minolta Co., Ltd.) specified in JIS Z 8781-4. After 24 hours, the cured product of the epoxy resin was taken out from the container, and the lightness L*, the chromaticity a*, and the chromaticity b* of the cured product of the epoxy resin having a thickness of 8 mm were measured at room temperature. The measurement results of the chromaticities a* and b* were shown in Tables 1 and 2.

### Example 1

Under conditions of 23° C. and 50% RH, 8.8 g (88 parts by mass) of “Polythiol QE340M” manufactured by Toray Fine Chemicals Co., Ltd. as a thiol compound containing two or more thiol groups in one molecule, 0.8 g (8 parts by mass) of “BB-AMINE 3138” manufactured by BB RESINS SRL as an amine compound A containing a primary amine and/or a secondary amine, and 0.4 g (4 parts by mass) of “EHC-30” manufactured by ADEKA Corporation as an amine compound B containing a tertiary amine were mixed with 10 g (100 parts by mass) of “jER828” (bisphenol A type epoxy resin, epoxy equivalent of 184 to 194 g/eq) manufactured by Mitsubishi Chemical Group Corporation as an epoxy resin containing two or more epoxy groups in one molecule with a spatula for 15 seconds, thereby obtaining an epoxy resin curable composition. The number of moles Me of the epoxy groups contained in the epoxy resin curable composition, the number of moles Mt of the thiol groups, the total number of moles M₁₊₂ of the primary amine and the secondary amine of the amine compound A, and the number of moles M₃ of the tertiary amine are shown in Table 1. In addition, the molar ratios M₁₊₂/Me, M₃/Me, M₃/M₁₊₂, and Mt/Me were calculated and described

When the curing time at 23° C. was measured using the obtained epoxy resin curable composition, the epoxy resin curable composition was cured in 6 minutes. In addition, the Shore D hardness after 3 hours from the start of curing was 78, and the Shore D hardness after 24 hours from the start of curing was 80. Furthermore, when the chromaticity of the cured product of the epoxy resin curable composition was measured, the chromaticity a* was −6 and the chromaticity b* was 18. These results are shown in Table 1.

### Example 2

An epoxy resin curable composition was obtained in the same manner as that of Example 1, except that the amount of the thiol compound was changed to 8.6 g (86 parts by mass), the amount of the amine compound A was changed to 1.1 g (11 parts by mass), and the amount of the amine compound B was changed to 0.3 g (3 parts by mass).

When the curing time at 23° C. was measured in the same manner as that of Example 1, the epoxy resin curable composition was cured in 5 minutes. In addition, the Shore D hardness after 3 hours from the start of curing was 78, and the Shore D hardness after 24 hours from the start of curing was 80. Furthermore, when the chromaticity of the cured product of the epoxy resin curable composition was measured, the chromaticity a* was −6 and the chromaticity b* was 19. These results are shown in Table 1.

### Example 3

An epoxy resin curable composition was obtained in the same manner as that of Example 1, except that the amount of the thiol compound was changed to 8.7 g (87 parts by mass), the amount of the amine compound A was changed to 1.1 g (11 parts by mass), and the amount of the amine compound B was changed to 0.2 g (2 parts by mass).

When the curing time at 23° C. was measured in the same manner as that of Example 1, the epoxy resin curable composition was cured in 5 minutes. In addition, the Shore D hardness after 3 hours from the start of curing was 79, and the Shore D hardness after 24 hours from the start of curing was 79. Furthermore, when the chromaticity of the cured product of the epoxy resin curable composition was measured, the chromaticity a* was −6 and the chromaticity b* was 17. These results are shown in Table 1.

### Example 4

An epoxy resin curable composition was obtained in the same manner as that of Example 1, except that the amount of the thiol compound was changed to 8.9 g (89 parts by mass), the amount of the amine compound A was changed to 0.9 g (9 parts by mass), and the amount of the amine compound B was changed to 0.2 g (2 parts by mass).

When the curing time at 23° C. was measured in the same manner as that of Example 1, the epoxy resin curable composition was cured in 6 minutes. In addition, the Shore D hardness after 3 hours from the start of curing was 77, and the Shore D hardness after 24 hours from the start of curing was 80. Furthermore, when the chromaticity of the cured product of the epoxy resin curable composition was measured, the chromaticity a* was −6 and the chromaticity b* was 16. These results are shown in Table 1.

### Example 5

An epoxy resin curable composition was obtained in the same manner as that of Example 1, except that the amount of the thiol compound was changed to 8.9 g (89 parts by mass) and the amount of the amine compound B was changed to 0.3 g (3 parts by mass).

When the curing time at 23° C. was measured in the same manner as that of Example 1, the epoxy resin curable composition was cured in 6 minutes. In addition, the Shore D hardness after 3 hours from the start of curing was 78, and the Shore D hardness after 24 hours from the start of curing was 80. Furthermore, when the chromaticity of the cured product of the epoxy resin curable composition was measured, the chromaticity a* was −6 and the chromaticity b* was 18. These results are shown in Table 1.

### Example 6

An epoxy resin curable composition was obtained in the same manner as that of Example 1, except that the amount of the amine compound A was changed to 1.5 g (15 parts by mass) and the amount of the amine compound B was changed to 0.1 g (1 part by mass).

When the curing time at 23° C. was measured in the same manner as that of Example 1, the epoxy resin curable composition was cured in 4 minutes. In addition, the Shore D hardness after 3 hours from the start of curing was 78, and the Shore D hardness after 24 hours from the start of curing was 76. Furthermore, when the chromaticity of the cured product of the epoxy resin curable composition was measured, the chromaticity a* was −5 and the chromaticity b* was 14. These results are shown in Table 1.

### Example 7

An epoxy resin curable composition was obtained in the same manner as that of Example 1, except that the amount of the thiol compound was changed to 4.4 g (44 parts by mass), the amount of the amine compound A was changed to 1.5 g (15 parts by mass), and the amount of the amine compound B was changed to 0.1 g (1 part by mass).

When the curing time at 23° C. was measured in the same manner as that of Example 1, the epoxy resin curable composition was cured in 5 minutes. In addition, the Shore D hardness after 3 hours from the start of curing was 84, and the Shore D hardness after 24 hours from the start of curing was 83. Furthermore, when the chromaticity of the cured product of the epoxy resin curable composition was measured, the chromaticity a* was −6 and the chromaticity b* was 17. These results are shown in Table 1.

### Comparative Example 1

An epoxy resin curable composition was obtained in the same manner as that of Example 1, except that the amount of the thiol compound was changed to 8.9 g (89 parts by mass), the amount of the amine compound A was changed to 1.1 g (11 parts by mass), and the amine compound B was not blended.

When the curing time at 23ºC was measured in the same manner as that of Example 1, the epoxy resin curable composition was cured in 6 minutes. In addition, the Shore D hardness after 3 hours from the start of curing was 72, and the Shore D hardness after 24 hours from the start of curing was 73. Furthermore, when the chromaticity of the cured product of the epoxy resin curable composition was measured, the chromaticity a* was −5 and the chromaticity b* was 7. These results are shown in Table 1.

### Comparative Example 2

An epoxy resin curable composition was obtained in the same manner as that of Example 1, except that the amount of the thiol compound was changed to 8.9 g (89 parts by mass), the amount of the amine compound B was changed to 1.1 g (11 parts by mass), and the amine compound A was not blended.

When the curing time at 23° C. was measured in the same manner as that of Example 1, the epoxy resin curable composition was cured in 5 minutes. In addition, the Shore D hardness after 3 hours from the start of curing was 82, and the Shore D hardness after 24 hours from the start of curing was 83. Furthermore, when the chromaticity of the cured product of the epoxy resin curable composition was measured, the chromaticity a* was −8 and the chromaticity b* was 37. These results are shown in Table 1.

### Comparative Example 3

An epoxy resin curable composition was obtained in the same manner as that of Example 1, except that the amount of the amine compound A was changed to 1.5 g (15 parts by mass) and the amount of the amine compound B was changed to 0.6 g (6 parts by mass).

When the curing time at 23° C. was measured in the same manner as that of Example 1, the epoxy resin curable composition was cured in 4 minutes. In addition, the Shore D hardness after 3 hours from the start of curing was 80, and the Shore D hardness after 24 hours from the start of curing was 78. Furthermore, when the chromaticity of the cured product of the epoxy resin curable composition was measured, the chromaticity a* was −5 and the chromaticity b* was 22. These results are shown in Table 2.

### Comparative Example 4

An epoxy resin curable composition was obtained in the same manner as that of Example 1, except that the amount of the amine compound A was changed to 0.3 g (3 parts by mass) and the amount of the amine compound B was changed to 0.6 g (6 parts by mass).

When the curing time at 23° C. was measured in the same manner as that of Example 1, the epoxy resin curable composition was cured in 7 minutes. In addition, the Shore D hardness after 3 hours from the start of curing was 82, and the Shore D hardness after 24 hours from the start of curing was 81. Furthermore, when the chromaticity of the cured product of the epoxy resin curable composition was measured, the chromaticity a* was −8 and the chromaticity b* was 23. These results are shown in Table 2.

### Comparative Example 5

An epoxy resin curable composition was obtained in the same manner as that of Example 1, except that the amount of the amine compound A was changed to 0.3 g (3 parts by mass) and the amount of the amine compound B was changed to 0.1 g (1 part by mass).

When the curing time at 23° C. was measured in the same manner as that of Example 1, the epoxy resin curable composition was cured in 15 minutes. In addition, the Shore D hardness after 3 hours from the start of curing was 46, and the Shore D hardness after 24 hours from the start of curing was 63. Furthermore, when the chromaticity of the cured product of the epoxy resin curable composition was measured, the chromaticity a* was −6 and the chromaticity b* was 12. These results are shown in Table 2.

### Comparative Example 6

An epoxy resin curable composition was obtained in the same manner as that of Example 1, except that the amount of the thiol compound was changed to 13.2 g (132 parts by mass), the amount of the amine compound A was changed to 1.5 g (15 parts by mass), and the amount of the amine compound B was changed to 0.6 g (6 parts by mass).

When the curing time at 23° C. was measured in the same manner as that of Example 1, the epoxy resin curable composition was cured in 5 minutes. In addition, the Shore D hardness after 3 hours from the start of curing was 29, and the Shore D hardness after 24 hours from the start of curing was 32. Furthermore, when the chromaticity of the cured product of the epoxy resin curable composition was measured, the chromaticity a* was −3 and the chromaticity b* was 15. These results are shown in Table 2.

### Comparative Example 7

An epoxy resin curable composition was obtained in the same manner as that of Example 1, except that the amount of the thiol compound was changed to 4.4 g (44 parts by mass), the amount of the amine compound A was changed to 1.5 g (15 parts by mass), and the amount of the amine compound B was changed to 0.6 g (6 parts by mass).

When the curing time at 23° C. was measured in the same manner as that of Example 1, the epoxy resin curable composition was cured in 5 minutes. In addition, the Shore D hardness after 3 hours from the start of curing was 84, and the Shore D hardness after 24 hours from the start of curing was 85. Furthermore, when the chromaticity of the cured product of the epoxy resin curable composition was measured, the chromaticity a* was −7 and the chromaticity b* was 25. These results are shown in Table 2.

### Comparative Example 8

An epoxy resin curable composition was obtained in the same manner as that of Example 1, except that the amount of the thiol compound was changed to 13.2 g (132 parts by mass), the amount of the amine compound A was changed to 0.3 g (3 parts by mass), and the amount of the amine compound B was changed to 0.6 g (6 parts by mass).

When the curing time at 23° ° C. was measured in the same manner as that of Example 1, the epoxy resin curable composition was cured in 9 minutes. In addition, the Shore D hardness after 3 hours from the start of curing was 38, and the Shore D hardness after 24 hours from the start of curing was 39. Furthermore, when the chromaticity of the cured product of the epoxy resin curable composition was measured, the chromaticity a* was −6 and the chromaticity b* was 16. These results are shown in Table 2.

### Comparative Example 9

An epoxy resin curable composition was obtained in the same manner as that of Example 1, except that the amount of the thiol compound was changed to 4.4 g (44 parts by mass), the amount of the amine compound A was changed to 0.3 g (3 parts by mass), and the amount of the amine compound B was changed to 0.6 g (6 parts by mass).

When the curing time at 23° C. was measured in the same manner as that of Example 1, the epoxy resin curable composition was cured in 6 minutes. In addition, the Shore D hardness after 3 hours from the start of curing was 83, and the Shore D hardness after 24 hours from the start of curing was 84. Furthermore, when the chromaticity of the cured product of the epoxy resin curable composition was measured, the chromaticity a* was −9 and the chromaticity b* was 26. These results are shown in Table 2.

### Comparative Example 10

An epoxy resin curable composition was obtained in the same manner as that of Example 1, except that the amount of the thiol compound was changed to 13.2 g (132 parts by mass), the amount of the amine compound A was changed to 0.3 g (3.0 parts by mass), and the amount of the amine compound B was changed to 0.1 g (1 part by mass).

When the curing time at 23° C. was measured in the same manner as that of Example 1, the epoxy resin curable composition was cured in 17 minutes. In addition, the Shore D hardness after 3 hours from the start of curing was 41, and the Shore D hardness after 24 hours from the start of curing was 44. Furthermore, when the chromaticity of the cured product of the epoxy resin curable composition was measured, the chromaticity a* was −5 and the chromaticity b* was 10. These results are shown in Table 2.

### Comparative Example 11

An epoxy resin curable composition was obtained in the same manner as that of Example 1, except that the amount of the thiol compound was changed to 4.4 g (44 parts by mass), the amount of the amine compound A was changed to 0.3 g (3 parts by mass), and the amount of the amine compound B was changed to 0.1 g (1 part by mass).

When the curing time at 23° C. was measured in the same manner as that of Example 1, the epoxy resin curable composition was cured in 12 minutes. In addition, the Shore D hardness after 3 hours from the start of curing was 10, and the Shore D hardness after 24 hours from the start of curing was 27. Furthermore, when the chromaticity of the cured product of the epoxy resin curable composition was measured, the chromaticity a* was −6 and the chromaticity b* was 12. These results are shown in Table 2.

TABLE 1

| | | | | | | | | | Comparative | Comparative |
|---|---|---|---|---|---|---|---|---|---|---|
| | | Example 1 | Example 2 | Example 3 | Example 4 | Example 5 | Example 6 | Example 7 | Example 1 | Example 2 |
| Epoxy resin (parts by mass) | | 100 | 100 | 100 | 100 | 100 | 100 | 100 | 100 | 100 |
| Thiol compound (parts by | | 88 | 86 | 87 | 89 | 89 | 88 | 44 | 89 | 89 |
| mass) | | | | | | | | | | |
| Amine compound A (parts | | 8 | 11 | 11 | 9 | 8 | 15 | 15 | 11 | 0 |
| by mass) | | | | | | | | | | |
| Amine compound B (parts | | 4 | 3 | 2 | 2 | 3 | 1 | 1 | 0 | 11 |
| by mass) | | | | | | | | | | |
| Number of moles Me of | | 0.59 | 0.59 | 0.59 | 0.59 | 0.59 | 0.59 | 0.59 | 0.59 | 0.59 |
| epoxy groups (mol) | | | | | | | | | | |
| Number of moles Mt of thiol | | 0.37 | 0.36 | 0.37 | 0.38 | 0.38 | 0.37 | 0.19 | 0.38 | 0.38 |
| groups (mol) | | | | | | | | | | |
| Number of moles M₁₁₂ of primary | | 0.16 | 0.22 | 0.22 | 0.18 | 0.16 | 0.29 | 0.29 | 0.22 | 0.00 |
| and secondary amino groups (mol) | | | | | | | | | | |
| Number of moles M₃ of tertiary | | 0.05 | 0.03 | 0.02 | 0.02 | 0.03 | 0.01 | 0.01 | 0.00 | 0.12 |
| amino group (mol) | | | | | | | | | | |
| Molar ratio M₁₁₂/Me | | 0.27 | 0.37 | 0.37 | 0.30 | 0.27 | 0.50 | 0.50 | 0.37 | 0.00 |
| Molar ratio M₃/Me | | 0.08 | 0.06 | 0.04 | 0.04 | 0.06 | 0.02 | 0.02 | 0.00 | 0.21 |
| Molar ratio M₃/M₁₁₂ | | 0.29 | 0.16 | 0.10 | 0.13 | 0.22 | 0.04 | 0.04 | 0.00 | 0.00 |
| Molar ratio Mt/Me | | 0.64 | 0.62 | 0.63 | 0.64 | 0.64 | 0.64 | 0.32 | 0.64 | 0.64 |
| Curing time (min) | | 6 | 5 | 5 | 6 | 6 | 4 | 5 | 6 | 5 |
| Hardness | After 3 hours | 78 | 78 | 79 | 77 | 78 | 78 | 84 | 72 | 82 |
| Shore D | After 24 hours | 80 | 80 | 79 | 80 | 80 | 76 | 83 | 73 | 83 |
| Chromaticity | a * | −6 | −6 | −6 | −6 | −6 | −5 | −6 | −5 | −8 |
| | b * | 18 | 19 | 17 | 16 | 18 | 14 | 17 | 7 | 37 |

TABLE 2

| | | Comparative | Comparative | Comparative | Comparative | Comparative |
|---|---|---|---|---|---|---|
| | | Example 3 | Example 4 | Example 5 | Example 6 | Example 7 |
| Epoxy resin (parts by mass) | | 100 | 100 | 100 | 100 | 100 |
| Thiol compound (parts by mass) | | 88 | 88 | 88 | 132 | 44 |
| Amine compound A (parts by mass) | | 15 | 3 | 3 | 15 | 15 |
| Amine compound B (parts by mass) | | 6 | 6 | 1 | 6 | 6 |
| Number of moles Me of epoxy groups (mol) | | 0.59 | 0.59 | 0.59 | 0.59 | 0.59 |
| Number of moles Mt of thiol groups (mol) | | 0.37 | 0.37 | 0.37 | 0.56 | 0.19 |
| Number of moles M₁₁₂of primary | | 0.29 | 0.06 | 0.06 | 0.29 | 0.29 |
| and secondary amino groups (mol) | | | | | | |
| Number of moles M₃ of tertiary amino group (mol) | | 0.07 | 0.07 | 0.01 | 0.07 | 0.07 |
| Molar ratio M₁₁₂/Me | | 0.50 | 0.10 | 0.10 | 0.50 | 0.50 |
| Molar ratio M₃/Me | | 0.12 | 0.12 | 0.02 | 0.12 | 0.12 |
| Molar ratio M₃/M₁₁₂ | | 0.23 | 1.15 | 0.19 | 0.23 | 0.23 |
| Molar ratio Mt/Me | | 0.64 | 0.64 | 0.64 | 0.95 | 0.32 |
| Curing time (min) | | 4 | 7 | 15 | 5 | 5 |
| Hardness | After 3 hours | 80 | 82 | 46 | 29 | 84 |
| Shore D | After 24 hours | 78 | 81 | 63 | 32 | 85 |
| Chromaticity | a * | −5 | −8 | −6 | −3 | −7 |
| | b * | 22 | 23 | 12 | 15 | 25 |

| | | Comparative | Comparative | Comparative | Comparative |
|---|---|---|---|---|---|
| | | Example 8 | Example 9 | Example 10 | Example 11 |
| Epoxy resin (parts by mass) | | 100 | 100 | 100 | 100 |
| Thiol compound (parts by mass) | | 132 | 44 | 132 | 44 |
| Amine compound A (parts by mass) | | 3 | 3 | 3 | 3 |
| Amine compound B (parts by mass) | | 6 | 6 | 1 | 1 |
| Number of moles Me of epoxy groups (mol) | | 0.59 | 0.59 | 0.59 | 0.59 |
| Number of moles Mt of thiol groups (mol) | | 0.56 | 0.19 | 0.56 | 0.19 |
| Number of moles M₁₁₂of primary | | 0.06 | 0.06 | 0.06 | 0.06 |
| and secondary amino groups (mol) | | | | | |
| Number of moles M₃ of tertiary amino group (mol) | | 0.07 | 0.07 | 0.01 | 0.01 |
| Molar ratio M₁₁₂/Me | | 0.10 | 0.10 | 0.10 | 0.10 |
| Molar ratio M₃/Me | | 0.12 | 0.12 | 0.02 | 0.02 |
| Molar ratio M₃/M₁₁₂ | | 1.15 | 1.15 | 0.19 | 0.19 |
| Molar ratio Mt/Me | | 0.95 | 0.32 | 0.95 | 0.32 |
| Curing time (min) | | 9 | 6 | 17 | 12 |
| Hardness | After 3 hours | 38 | 83 | 41 | 10 |
| Shore D | After 24 hours | 39 | 84 | 44 | 27 |
| Chromaticity | a * | −6 | −9 | −5 | −6 |
| | b * | 16 | 26 | 10 | 12 |

1-9. (canceled)

10. An epoxy resin curable composition comprising an epoxy resin containing two or more epoxy groups in one molecule, a thiol compound containing two or more thiol groups in one molecule, an amine compound A containing a primary amino group and/or a secondary amino group, and an amine compound B containing a tertiary amino group, wherein a molar ratio M₁₊₂/Me is 0.11 to 0.5 and a molar ratio M₃/Me is 0.005 to 0.1, in which Me is a number of moles of the epoxy groups contained in the epoxy resin curable composition, M₁₊₂ is a total number of moles of the primary amino group and the secondary amino group, and M₃ is a number of moles of the tertiary amino group.

11. The epoxy resin curable composition according to claim 10, wherein a molar ratio M₃/M₁₊₂ of the number of moles M₃ of the tertiary amino group to the total number of moles M₁₊₂ of the primary amino group and the secondary amino group is 0.04 to 1.1.

12. The epoxy resin curable composition according to claim 10, wherein a molar ratio Mt/Me of the number of moles Me of the epoxy groups to the number of moles Mt of the thiol groups contained in the epoxy resin curable composition is 0.1 to 0.9.

13. The epoxy resin curable composition according to claim 10, wherein the thiol compound does not contain a carbonyl group.

14. The epoxy resin curable composition according to claim 10, wherein a chromaticity a* and a chromaticity b* in an L*a*b* color system of a cured product are −10 to +10 and −20 to +20, respectively.

15. The epoxy resin curable composition according to claim 10, wherein a curing time when 10 g of the epoxy resin curable composition is used and cured at 23° C. and 50% RH is 1 to 15 minutes.

16. The epoxy resin curable composition according to claim 10, wherein when the epoxy resin curable composition is applied to a thickness of 6.0 mm or more and is cured at 23° C. and 50% RH, a Shore D hardness in accordance with JIS K7215 after 3 hours from a start of curing is 75 or more, and the Shore D hardness in accordance with JIS K7215 after 24 hours from the start of curing is 75 or more.

17. The epoxy resin curable composition according to claim 10, wherein the epoxy resin curable composition is used for an adhesive.

18. An adhesive comprising the epoxy resin curable composition according to claim 10.
